(19) United States
(12) Patent Application Publication
(10) Pub. No.: US 2022/0353256 A1
(43) Pub. Date: Nov. 3, 2022

(54) USAGE-LIMITED PASSCODES FOR AUTHENTICATION BOOTSTRAPPING

(71) Applicant: Microsoft Technology Licensing, LLC, Redmond, WA (US)

(72) Inventors: Inbar CIZER KOBRINSKY, Seattle, WA (US); Anirban BASU, Sammamish, WA (US); Ananda SINHA, Sammamish, WA (US); Sarat SUBRAMANIAM, Bellevue, WA (US); Alexander T. WEINERT, Seattle, WA (US); Nitika GUPTA, Seattle, WA (US); Kamen MOUTAFOV, Sammamish, WA (US); Ashok CHANDRASEKARAN, Redmond, WA (US)

(21) Appl. No.: 17/244,020

(22) Filed: Apr. 29, 2021

(51) Int. Cl. H04L 29/06

(52) U.S. Cl. CPC H04L 63/0838; H04L 63/0861; H04L 63/0876; H04L 63/105; H04L 63/102; H04L 63/20

(57) ABSTRACT

Usage-limited passcodes support authentication when onboarding new employees, when recovering access after an enrolled device is lost or temporarily unavailable, or when registering passwordless authentication methods for new devices during an out of the box setup, among other scenarios. Usage-limited passcodes are also referred to as “temporary access passes” or TAPs. TAP usage may be limited to a specific number of uses, particular kinds of uses, certain time periods, or a combination thereof. A TAP includes a code string and an implementation of corresponding tokens, rights, and other identity aspects within an enhanced access control infrastructure. TAP usage may supplement or replace other authentication, and in particular may replace authentication through a username and password combination, thereby enhancing both usability and security. Self-service identity confirmation may be used to obtain a TAP. Redirection to a federated domain identity provider may be avoided during TAP authentication.

### BACKGROUND

Attacks on computing systems take many different forms, including some forms which are difficult to predict, and forms which may vary from one situation to another. Accordingly, one of the guiding principles of cybersecurity is “defense in depth”. In practice, defense in depth is often pursed by forcing attackers to encounter multiple different kinds of security mechanisms at multiple different locations around or within a computing system. No single security mechanism is able to detect every kind of cyberattack, or able to end every detected cyberattack. But sometimes combining and layering a sufficient number and variety of defenses will deter an attacker, or at least limit the scope of harm from an attack.

To implement defense in depth, cybersecurity professionals consider the different kinds of attacks that could be made. They select defenses based on criteria such as: which attacks are most likely to occur, which attacks are most likely to succeed, which attacks are most harmful if successful, which defenses are in place, which defenses could be put in place, and the costs and procedural changes and training involved in putting a particular defense in place.

In particular, many computing systems require entry of a username and password that match internal records before granting access to an account and its associated resources and privileges. Users may be encouraged or compelled to use long complex passwords, to change passwords at regular intervals, and to use a unique password for each of their accounts. Despite such efforts, many professionals consider passwords to be a weak form of protection which should be supplemented. At the same time, the scope of access granted to many users has increased due to the federation of different systems and single sign-on approaches, which may be available even to users whose passwords are not supplemented by other authentication requirements. Striking a good balance between security, convenience, and cost is a continuing challenge.

### SUMMARY

Some embodiments taught herein balance security, convenience, and cost by supporting authentication of an asserted digital identity based on usage-limited passcodes. Unlike a user-defined password, a usage-limited passcode is subject to usage constraints, and when issued after identity confirmation may be used in some embodiments to bootstrap strong authentication methods such as passwordless authentication methods. Passcode usage constraints may limit the number of uses, the kind of uses, or the usage time period of the passcode, for example. Usage-limited passcodes may be particularly helpful in scenarios such as onboarding new employees, or recovering from a loss or unavailability of a smart phone that was used for authentication.

Some embodiments use or provide a hardware and software combination which is configured, e.g., by tailored software, to perform passwordless authentication support steps which include receiving a usage-limited passcode, confirming that the usage-limited passcode has not expired or been used a maximum number of permitted times, ascertaining a user identity which is securely and exclusively associated with the usage-limited passcode within the system, and registering in the system a passwordless authentication method for authentication of the user identity.

Some embodiments provide or use a process for providing passwordless authentication support, including receiving a usage-limited passcode, confirming that the usage-limited passcode satisfies a set of one or more usage constraints, ascertaining a user identity which is securely associated with the usage-limited passcode within the computing system, and performing at least one cybersecurity operation within the computing system in reliance on the usage-limited passcode as an authentication credential. The cybersecurity operation is ineffective in response to a username and a password alone for authentication.

Some embodiments provide or use a computer-readable storage device configured with data and instructions which upon execution by a processor cause a cloud computing system to perform such a process, or another process such as on that includes ascertaining a user identity which is securely and exclusively associated with the usage-limited passcode within the system, and authenticating the user identity in the system based on the usage-limited passcode.

Other technical activities and characteristics pertinent to teachings herein will also become apparent to those of skill in the art. The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. The innovation is defined with claims as properly understood, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating computer systems generally and also illustrating configured storage media generally;

FIG. 2 is a block diagram illustrating aspects of a computing system configured with authentication enhancements taught herein;

FIG. 3 is a block diagram illustrating some examples and aspects of some authentication methods;

FIG. 4 is a block diagram illustrating some aspects of some usage-limited passcodes or related items;

FIG. 5 is a flowchart illustrating steps in some authentication support processes; and

FIG. 6 is a flowchart further illustrating steps in some authentication support processes.

### DETAILED DESCRIPTION

### Overview

Innovations may expand beyond their origins, but understanding an innovation's origins can help one more fully appreciate the innovation. In the present case, some teachings described herein were motivated by insights gained as innovators worked to improve the effectiveness and usability of security controls. Two scenarios held particular interest for the innovators: onboarding new employees, and restoring access to an elevated privilege user (e.g., an executive) whose authentication normally uses a smart phone or another device when the device is unavailable to that user.

A user gets authenticated so that an access control infrastructure will associate the user with the correct resource set, e.g., the correct email, services, documents, financial information, and so on, and thus allow the user to access those resources. The innovators recognized that authentication systems are often vulnerable when they rely entirely on a username and password combination to authenticate user identity. Passwords are often weak, reused at many places, and an easy target for attackers. Hence, device-based strong passwordless authentication methods are sometimes used, both to significantly improve the security posture and to simplify authentication methods management for users.

However, one technical challenge faced by enterprises that want to completely migrate to a passwordless world is determining how users register their passwordless authentication method the first time they login. A first-time user may be given a temporary password, while some authentication systems ask for a two-factor authentication setup first. One process is to use the password and an alternative verification option, e.g., a call or message to a phone number, to confirm the identity first, and then register the passwordless method. But even when the user moves to passwordless methods, the user's password and phone number remain in the system. Some users do not use their password and phone number anymore for authentication, so attackers may be able to harvest these credentials and use them to gain access to the system. In addition, if the user forgets the passwordless authentication methods, or lacks access to devices whose possession is part of authentication, then the user may be unable to log in.

In response, the innovators devised authentication support technology utilizing a “temporary access pass” (TAP), also referred to herein as a “usage-limited passcode”. A TAP should not be confused with a temporary password. The TAP (as the name suggests) is temporary in nature. In some embodiments it is a strong credential for a user, so no alternative method registration is required.

In some embodiments, the TAP can be restricted for a one-time use, or be restricted to use within a certain time period. As a result, when the user registers a permanent authentication method and does not need the TAP anymore, the TAP expires after the first use or after the expiry time. Use usage constraints make the TAP have little if any value to an attacker, and give cloud or other admins better control of user authentication methods so they can worry less about unused credentials lying around in the system.

In some embodiments, the TAP is a self-destructive temporary code, which serves as a strong credential to bootstrap passwordless methods for later authentication attempts. A TAP may also be used by administrators to unblock users temporarily, in case their primary passwordless device is unavailable.

The foregoing examples and scenarios are not comprehensive. Other scenarios, technical challenges, and innovations will be apparent to one of skill upon reading the full disclosure herein.

Operating Environments

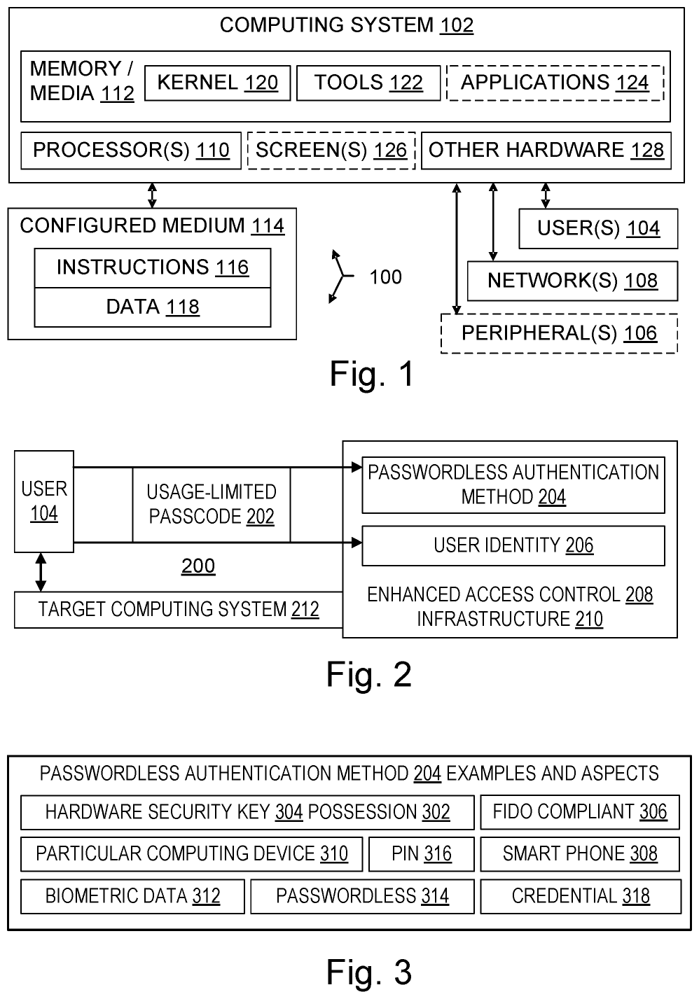

With reference to FIG. 1, an operating environment 100 for an embodiment includes at least one computer system 102. The computer system 102 may be a multiprocessor computer system, or not. An operating environment may include one or more machines in a given computer system, which may be clustered, client-server networked, and/or peer-to-peer networked within a cloud. An individual machine is a computer system, and a network or other group of cooperating machines is also a computer system. A given computer system 102 may be configured for end-users, e.g., with applications, for administrators, as a server, as a distributed processing node, and/or in other ways.

Human users 104 may interact with the computer system 102 by using displays, keyboards, and other peripherals 106, via typed text, touch, voice, movement, computer vision, gestures, and/or other forms of I/O. A screen 126 may be a removable peripheral 106 or may be an integral part of the system 102. A user interface may support interaction between an embodiment and one or more human users. A user interface may include a command line interface, a graphical user interface (GUI), natural user interface (NUI), voice command interface, and/or other user interface (UI) presentations, which may be presented as distinct options or may be integrated.

System administrators, network administrators, cloud administrators, security analysts and other security personnel, operations personnel, developers, testers, engineers, auditors, and end-users are each a particular type of user 104. Automated agents, scripts, playback software, devices, and the like acting on behalf of one or more people may also be users 104, e.g., to facilitate testing a system 102. Storage devices and/or networking devices may be considered peripheral equipment in some embodiments and part of a system 102 in other embodiments, depending on their detachability from the processor 110. Other computer systems not shown in FIG. 1 may interact in technological ways with the computer system 102 or with another system embodiment using one or more connections to a network 108 via network interface equipment, for example.

Each computer system 102 includes at least one processor 110. The computer system 102, like other suitable systems, also includes one or more computer-readable storage media 112, also referred to as computer-readable storage devices 112. Storage media 112 may be of different physical types. The storage media 112 may be volatile memory, nonvolatile memory, fixed in place media, removable media, magnetic media, optical media, solid-state media, and/or of other types of physical durable storage media (as opposed to merely a propagated signal or mere energy). In particular, a configured storage medium 114 such as a portable (i.e., external) hard drive, CD, DVD, memory stick, or other removable nonvolatile memory medium may become functionally a technological part of the computer system when inserted or otherwise installed, making its content accessible for interaction with and use by processor 110. The removable configured storage medium 114 is an example of a computer-readable storage medium 112. Some other examples of computer-readable storage media 112 include built-in RAM, ROM, hard disks, and other memory storage devices which are not readily removable by users 104. For compliance with current United States patent requirements, neither a computer-readable medium nor a computer-readable storage medium nor a computer-readable memory is a signal per se or mere energy under any claim pending or granted in the United States.

The storage device 114 is configured with binary instructions 116 that are executable by a processor 110; “executable” is used in a broad sense herein to include machine code, interpretable code, bytecode, and/or code that runs on a virtual machine, for example. The storage medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as product characteristics, inventories, physical measurements, settings, images, readings, targets, volumes, and so forth. Such data is also transformed by backup, restore, commits, aborts, reformatting, and/or other technical operations.

Although an embodiment may be described as being implemented as software instructions executed by one or more processors in a computing device (e.g., general purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, an embodiment may include hardware logic components 110, 128 such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an embodiment may be grouped into interacting functional modules based on their inputs, outputs, and/or their technical effects, for example.

In addition to processors 110 (e.g., CPUs, ALUs, FPUs, TPUs and/or GPUs), memory/storage media 112, and displays 126, an operating environment may also include other hardware 128, such as batteries, buses, power supplies, wired and wireless network interface cards, for instance. The nouns “screen” and “display” are used interchangeably herein. A display 126 may include one or more touch screens, screens responsive to input from a pen or tablet, or screens which operate solely for output. In some embodiments, peripherals 106 such as human user I/O devices (screen, keyboard, mouse, tablet, microphone, speaker, motion sensor, etc.) will be present in operable communication with one or more processors 110 and memory.

In some embodiments, the system includes multiple computers connected by a wired and/or wireless network 108. Networking interface equipment 128 can provide access to networks 108, using network components such as a packet-switched network interface card, a wireless transceiver, or a telephone network interface, for example, which may be present in a given computer system. Virtualizations of networking interface equipment and other network components such as switches or routers or firewalls may also be present, e.g., in a software-defined network or a sandboxed or other secure cloud computing environment. In some embodiments, one or more computers are partially or fully “air gapped” by reason of being disconnected or only intermittently connected to another networked device or remote cloud. In particular, functionality for authentication support enhancements taught herein could be installed on an air gapped network such as a highly secure cloud, and then be updated periodically or on occasion using removable media. A given embodiment may also communicate technical data and/or technical instructions through direct memory access, removable nonvolatile storage media, or other information storage-retrieval and/or transmission approaches.

One of skill will appreciate that the foregoing aspects and other aspects presented herein under “Operating Environments” may form part of a given embodiment. This document's headings are not intended to provide a strict classification of features into embodiment and non-embodiment feature sets.

One or more items are shown in outline form in the Figures, or listed inside parentheses, to emphasize that they are not necessarily part of the illustrated operating environment or all embodiments, but may interoperate with items in the operating environment or some embodiments as discussed herein. It does not follow that items not in outline or parenthetical form are necessarily required, in any Figure or any embodiment. In particular, FIG. 1 is provided for convenience; inclusion of an item in FIG. 1 does not imply that the item, or the described use of the item, was known prior to the current innovations.

More About Systems

FIG. 2 illustrates a computing system 200 that has been enhanced according to authentication support teachings provided herein. The example system 200 includes all of the subject matter shown in FIG. 2 except a human user 104. Other systems 200 omit additional subject matter, e.g., one or more of a passwordless authentication method 204, a security infrastructure 210, or a secured system 212 are omitted from system 200 in other variants.

In this example, a usage-limited passcode 202 is sent to an enhanced access control infrastructure 210 by a user 104, e.g., by typing in the passcode. The infrastructure 210 performs access control 208 over secured resources, e.g., over a computing system 212, 102 that the user 104 wants to access. The infrastructure 210 confirms that the passcode 202 is valid and ascertains a digital identity 206 that corresponds to the user 104 and the passcode 202. If the passcode is not valid, access is not granted. If the passcode is valid, access is granted. If access is granted, the user 104 may then register a passwordless authentication method 204 with the infrastructure 210, so that the user can have access again to the resources of the identity 206 after the passcode 202 expires, or reaches its maximum number of allowed uses, or otherwise becomes invalid.

FIG. 3 shows some examples or aspects of some passwordless authentication methods 204. This is not meant to be a comprehensive list. These items and other items relevant to authentication are discussed at various points herein, and additional details regarding them are provided in the discussion of a List of Reference Numerals later in this disclosure document.

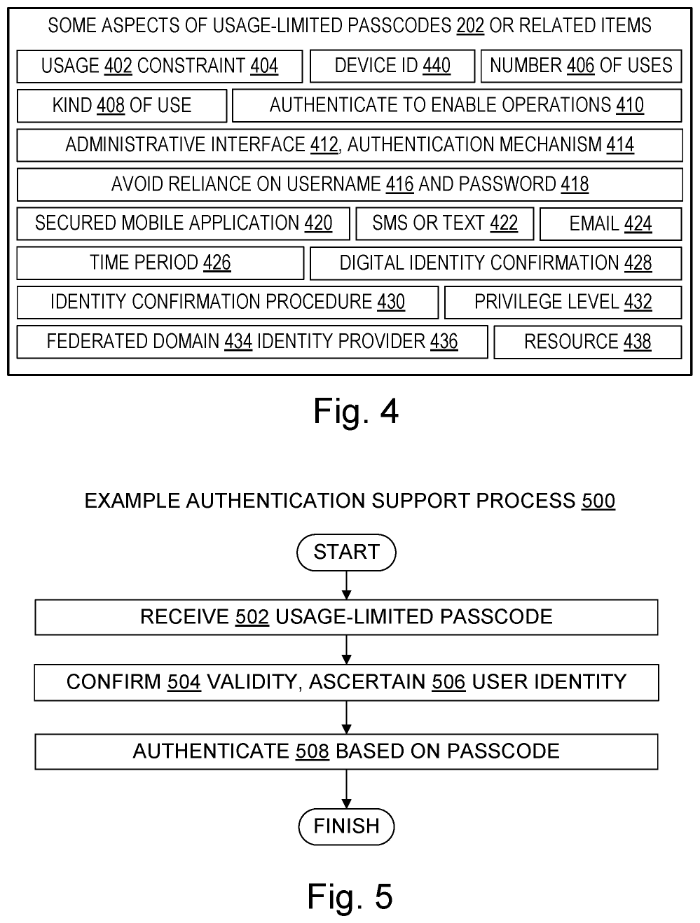

FIG. 4 shows some examples or aspects of some usage-limited passcodes 202. This is not meant to be a comprehensive list. These items and other items relevant to usage-limited passcodes 202 or authentication or activities after authentication are discussed at various points herein, and additional details regarding them are provided in the discussion of a List of Reference Numerals later in this disclosure document.

Some embodiments use or provide a functionality-enhanced system, such as system 200 or another system 102 that is enhanced as taught herein. In some embodiments, an enhanced system which is configured with passwordless authentication support includes a digital memory 112 and a processor 110 in operable communication with the memory. The enhanced computing system is configured to perform passwordless authentication support steps including automatically receiving 502 a usage-limited passcode 202, confirming that the usage-limited passcode has not expired or been used a maximum number of permitted times, ascertaining 506 a user identity 206 which is securely and exclusively associated with the usage-limited passcode within the system, and registering 602 in the system a passwordless authentication method 204 for authentication of the user identity.

In some embodiments, the passwordless authentication method 204 includes at least one of the following: a FIDO-compliant 306 passwordless 314 authentication method 204; a passwordless 314 authentication method 204 based on possession 302 of a hardware security key 304; a passwordless 314 authentication method 204 based on possession 302 of a particular smart phone 308; a passwordless 314 authentication method 204 based on possession 302 of a particular computing device 310, 102; or a passwordless 314 authentication method 204 based on biometric data 312.

Some embodiments are further characterized by at least one of the following usage constraints: the usage-limited passcode 202 is treated 604 by the system as invalid after the passwordless authentication method 204 has been registered 602; the usage-limited passcode 202 is treated 606 by the system as valid for a predetermined number 406 of additional uses after being used to register 602 the passwordless authentication method 204, and the usage-limited passcode is treated 604 by the system as invalid otherwise; the usage-limited passcode 202 is treated 606 by the system as valid for registering 602 at least one additional passwordless authentication method 204 for authentication of the user identity 206, and the usage-limited passcode is treated 604 by the system as invalid otherwise; or the usage-limited passcode is bound to a device having a device identifier 440, and is treated 604 by the system as invalid if received 502 from a device 102 which does not have that bound device's device identifier 440. For example, an admin could issue a TAP 202 to a new employee, with the TAP configured for valid use solely from the new employee's smartphone and solely on the new employee's scheduled first day at work.

Some embodiments include an administrative interface 412 which is secured by an administrator authentication mechanism 414. The administrative interface is configured to display 614 the usage-limited passcode 202. In some embodiments, the administrative interface 412 is configured to display 614 the usage-limited passcode 202 only once; it cannot be recalled after the initial display is over.

In some embodiments, the system 200 includes a secured resource 438, the secured resource is accessible to the user identity 206 in response to a first authentication 508 attempt 642 which uses the registered passwordless authentication method, and the secured resource is secured 612 against access 610 by a second authentication attempt which relies on only a username 416 and password 418 as authentication credentials.

Other system embodiments are also described herein, either directly or derivable as system versions of described processes or configured media, duly informed by the extensive discussion herein of computing hardware.

Although specific authentication support examples are shown in the Figures, an embodiment may depart from those examples. For instance, items shown in different Figures may be included together in an embodiment, items shown in a Figure may be omitted, functionality shown in different items may be combined into fewer items or into a single item, items may be renamed, or items may be connected differently to one another.

Examples are provided in this disclosure to help illustrate aspects of the technology, but the examples given within this document do not describe all of the possible embodiments. A given embodiment may include additional or different security controls, technical features, mechanisms, access controls, operational sequences, data structures, or other functionalities for instance, and may otherwise depart from the examples provided herein.

Processes (a.k.a. Methods)

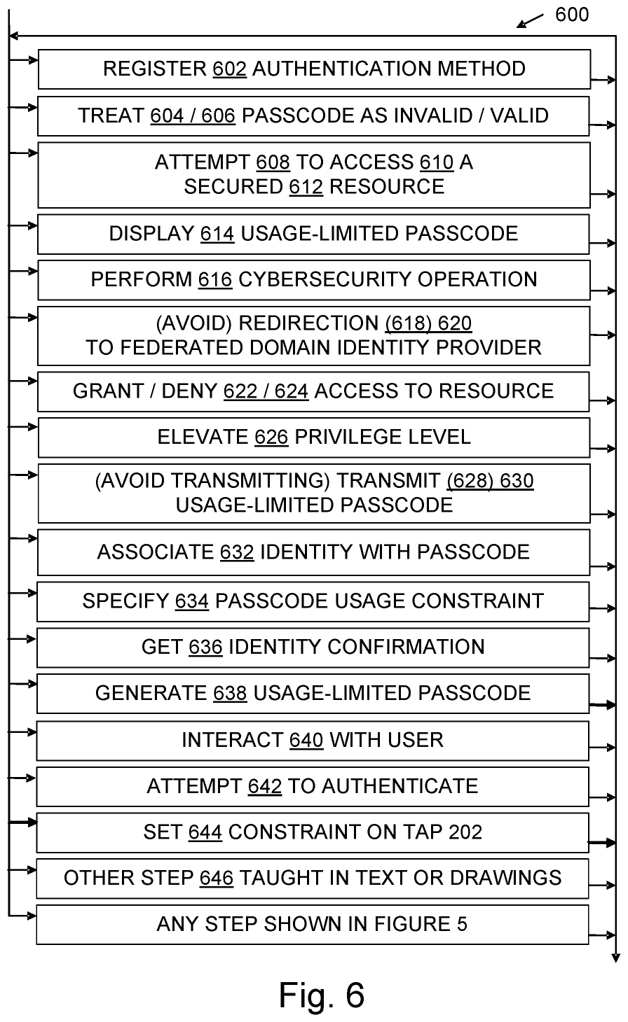

FIGS. 5 and 6 illustrate process families 500, 600 that may be performed or assisted by an enhanced system, such as system 200 or another authentication functionality enhanced system as taught herein. Such processes may also be referred to as “methods” in the legal sense of that word.

Technical processes shown in the Figures or otherwise disclosed will be performed automatically, e.g., by an enhanced security infrastructure, unless otherwise indicated. Some related processes may also be performed in part automatically and in part manually to the extent action by a human person is implicated, e.g., a human user may ask for a TAP 202 and a human admin may command a system 200 to generate a TAP and then tell the TAP to the user, but no process contemplated as innovative herein is entirely manual.

In a given embodiment zero or more illustrated steps of a process may be repeated, perhaps with different parameters or data to operate on. Steps in an embodiment may also be done in a different order than the top-to-bottom order that is laid out in FIGS. 5 and 6. Steps may be performed serially, in a partially overlapping manner, or fully in parallel. In particular, the order in which action items of FIGS. 5 and 6 are traversed to indicate the steps performed during a process may vary from one performance of the process to another performance of the process. Steps may also be omitted, combined, renamed, regrouped, be performed on one or more machines, or otherwise depart from the illustrated flow, provided that the process performed is operable and conforms to at least one claim.

Some embodiments use or provide a process providing passwordless authentication support, the process including the following automatic steps: receiving 502 a usage-limited passcode 202; confirming 504 that the usage-limited passcode 202 satisfies a set of one or more usage constraints 404; ascertaining a user identity 206 which is securely associated 632 with the usage-limited passcode within the computing system; and performing 616 at least one cybersecurity operation 410 within the computing system in reliance on the usage-limited passcode as an authentication credential, the cybersecurity operation ineffective in response to a username 416 and a password 418 alone for authentication.

In some embodiments, the cybersecurity operation 410 includes at least one of the following: granting 622 access to a secured 612 resource 438; registering 602 a passwordless 314 authentication method 204; or elevating 626 a privilege level 432.

In some embodiments, the cybersecurity operation 410 is also ineffective (e.g., barred, or prevented from accomplishing the desired effects) in response to any existing authentication credential 318 of the user identity other than the usage-limited passcode 202.

In some embodiments, multiple user identities 206 are each securely associated 632 with the usage-limited passcode 202 within the computing system at a given time.

In some embodiments, the process further includes at least one of the following: transmitting 630 the usage-limited passcode 202 via a secured mobile application 420; avoiding 628 transmitting the usage-limited passcode via email 424; or avoiding 628 transmitting the usage-limited passcode via SMS or text 422.

In some embodiments, the process further includes setting 644 at least one of the following usage constraints 404 on the usage-limited passcode: a usage count constraint specifying 634 a maximum number 406 of times the usage-limited passcode is effectively usable; a usage periods constraint specifying 634 a time period 426 inside of which the usage-limited passcode is effective and outside of which the usage-limited passcode is ineffective; a usage kind 408 constraint specifying one or more cybersecurity operations which are effective if authenticated by the usage-limited passcode; or a usage kind 408 constraint specifying one or more cybersecurity operations which are effective only if authenticated by the usage-limited passcode.

In some embodiments, the process further includes getting 636 a digital identity confirmation 428 which confirms an identity 206 claim; and securely associating 632 the usage-limited passcode 202 with the user identity 206 based at least in part on the digital identity confirmation.

In some embodiments, the process further includes interacting 640 with a user 104 during a self-service identity confirmation procedure 430; generating 638 the usage-limited passcode; and securely associating 632 the usage-limited passcode with the user identity based at least in part on a result of the self-service identity confirmation procedure.

Configured Storage Media

Some embodiments include a configured computer-readable storage medium 112. Storage medium 112 may include disks (magnetic, optical, or otherwise), RAM, EEPROMS or other ROMs, and/or other configurable memory, including in particular computer-readable storage media (which are not mere propagated signals). The storage medium which is configured may be in particular a removable storage medium 114 such as a CD, DVD, or flash memory. A general-purpose memory, which may be removable or not, and may be volatile or not, can be configured into an embodiment using items such as usage-limited passcodes 202, passwordless authentication methods 204, digital user identities 206, or software fully or partially implementing flows shown in FIG. 5 or 6, in the form of data 118 and instructions 116, read from a removable storage medium 114 and/or another source such as a network connection, to form a configured storage medium. The configured storage medium 112 is capable of causing a computer system 102 to perform technical process steps for authentication in a computing system, as disclosed herein. The Figures thus help illustrate configured storage media embodiments and process (a.k.a. method) embodiments, as well as system and process embodiments. In particular, any of the process steps illustrated in FIG. 5 or 6, or otherwise taught herein, may be used to help configure a storage medium to form a configured storage medium embodiment.

Some embodiments use or provide a computer-readable storage medium 112, 114 configured with data 118 and instructions 116 which upon execution by at least one processor 110 cause a cloud or other computing system to perform a process for authentication support. This process includes: receiving 502 a usage-limited passcode; confirming 504 that the usage-limited passcode is valid; ascertaining 506 a user identity which is securely and exclusively associated with the usage-limited passcode within the system; and authenticating 508 the user identity in the system based on the usage-limited passcode.

In some embodiments, the process includes registering 602 in the system a passwordless authentication method for authentication of the user identity, and the passwordless authentication method is based on at least one of the following: possession 302 of an enrolled device 310 and a PIN 316; or possession 302 of an enrolled device 310 and a biometric characteristic 312.

Some embodiments are characterized by a usage constraint 404 under which the usage-limited passcode is treated by the system as invalid after one successful sign-in. Some embodiments are characterized by a usage constraint 404 under which the usage-limited passcode is treated by the system as valid for a predetermined number of uses, and the usage-limited passcode is then treated by the system as invalid.

In some embodiments, the user identity 206 is part of a federated domain 434 having a federated domain identity provider 436, and authenticating 508 the user identity in the system based on the usage-limited passcode includes avoiding 618 redirection to the federated domain identity provider.

In some embodiments, the process further includes at least one of the following: granting 622 access to a secured 612 resource 438; registering 602 a passwordless 314 authentication method 204; or elevating 626 a privilege level 432.

### Additional Examples and Observations

One of skill will recognize that not every part of this disclosure, or any particular details therein, are necessarily required to satisfy legal criteria such as enablement, written description, or best mode. Any apparent conflict with any other patent disclosure, even from the owner of the present innovations, has no role in interpreting the claims presented in this patent disclosure. With this understanding, which pertains to all parts of the present disclosure, some additional examples and observations are offered in the following sections.

As a functional matter, a temporary access pass (TAP) includes at least two parts: a passcode, and an implementation. Some embodiments also include a link to the passcode, e.g., the TAP may be issued by an admin in the form of a hyperlink to the passcode, as opposed to being issued in the form of the passcode itself. For convenience the reference numeral 202 is applied to the passcode string (or the link and the passcode string, if a link is used for passcode issuance), with the understanding that the functionality of the passcode depends on an implementation, e.g., an enhanced access control infrastructure 210. So the implementation is implicitly (and at times explicitly) part of what is referenced by numeral 202. The passcode per se is a string of characters given to a person, either directly or via a link. The implementation is the internal data and software that define the lifespan, permitted number of uses, permitted kinds of uses, expected user identity, and other functional characteristics and behavior of the system 200 with regard to the passcode. A TAP passcode per se all by itself may look the same as a conventional passcode or one-time-password, but it does not enable the identical functionality, because of how a TAP implementation treats the TAP passcode.

For example, in some embodiments a system 200 receives a TAP passcode, confirms it is not expired, figures out what digital user identity the TAP was meant for use with (e.g., from a user principal name typed in by that user, or from a lookup table that indicates which user the TAP was issued for), implicitly accepts that the TAP was in fact given to the human who owns that digital user identity, and registers one or more passwordless authentication methods for that digital user identity.

In one embodiment design, a Temporary Access Pass (TAP) enables passwordless scenarios, as a time limited passcode that admin issues to users for one time or multiple time use, to be used for bootstrap credentials or recovery. It is a strong credential in that it is treated as if multifactor authentication (MFA) criteria are satisfied by it.

In one example, a Microsoft service referred to internally as “CCE” (variously expanded internally as “Cloud Credentials Endpoint” or “Credential Configuration Endpoint”) provides TAP management API as part of a StrongAuth API. Similar functionality may be employed in other clouds, with other authorized vendors. All management (e.g., create, read, update, destroy) operations of TAP will go through CCE.

To create a Temporary Access Pass, one suitable call is:

```
POST ~/users({userKey})/authentication/temporaryAccessPassMethods
Request body:
{
  “startDateTime”: “yyyymmddssss”, // placeholder
  “lifetimeInMins”: mmmm, // placeholder
  “isUsableOnce”: True
}
```

startDateTime. If omitted, may use the creationTime as startTime (basically UTC now). StartTime cannot be a time in the past.
lifetimeInMins: Validate this property with policy min, max settings, e.g., confirm it is within defined limits. If omitted, a value defined from policy will be used. (e.g., Min 10 mins, Max: 30 days, default 24 hours)
isUsableOnce: Validate this flag with policy. Most restricted setting wins, e.g., if policy is defined for multiple use and this flag is True, user TAP can be used only once. (e.g., status code 201 created)
If policy is defined for one time use and this flag is False, user TAP cannot be created for multiple use. (e.g., status code 400 bad request with reason)
This flag is stored in, e.g., Microsoft Online Directory Service (MSODS).

```
Response:
{
  “id”: “ididididididididid”, // placeholder
  “temporaryAccessPass”: “<random generated string>”,
  “createdDateTime”: “yyyymmddssss”, // placeholder
  “startDateTime”: “yyyymmddssss”, // placeholder
  “lifetimeInMins”: mmmm, // placeholder
  “isUsableOnce”: True
}
```

Length of temporary access pass is defined by policy settings, e.g., min and max length of access pass. (e.g., Min: 8 characters Max: 48 characters) Temporary access pass algorithm should be FIPS compliant.

To get a Temporary Access Pass, some suitable calls are:

```
GET ~/users({userKey})/authentication/temporaryAccessPassMethods
GET
~/users({userKey})/authentication/temporaryAccessPassMethods({authMethodKey})
Response:
{
  “id”: “ididididididididid”, // placeholder
  “temporaryAccessPass”: null,
  “createdDateTime”: “yyyymmddssss”, // placeholder
  “startDateTime”: “yyyymmddssss”, // placeholder
  “lifetimeInMins”: mmmm, // placeholder
  “isUsableOnce”: True
}
To delete a Temporary Access Pass, one suitable call is:
Delete
~/users({userKey})/authentication/temporaryAccessPassMethods({authMethodId})
Response:
```

204 no content

As to dependencies, in one example a data structure referred to internally as an Active Directory® “graph” can be utilized, in that CCE will call a Patch User API to create and update temporary access pass for user and a Get user API to get temporary access pass for user (mark of Microsoft Corporation). An iUsableOnce flag will be stored in MSODS during creation of a temporary access pass. Similar functionality can be used by other authorized vendors.

To clear an expired temporary access pass CCE will not do any clean up. MSODS will clean up a temporary access pass after, e.g., seven days of expiration and add an audit log entry that explains the temporary access pass was deleted for user. Telemetry metrics for temporary access pass user auth method creation on CCE side may include, e.g., TAP creation (total, success or failure), TAPs created per tenant and an overall total, one time versus multiple use TAP creation, and TAP deletion (total, success or failure)

Several additional scenarios will now be presented to illustrate aspects of TAPs 202 and their usage. One of skill will infer technical characteristics of TAPs and other artifacts from these scenarios in view of the teachings provided in this disclosure as a whole.

Onboarding a new passwordless user using a cloud portal. An Authentication Policy Admin can configure an Access Pass policy for a tenant. Maria is the Privileged Authentication Admin for Contoso. She would like to enable Passwordless authentication in the tenant. She goes to an Authentication Methods blade in an identity directory interface and enables a group of users to FIDO and Phone sign-in. Since she would like new users to use passwordless, she also enables an Access Pass 202 credential and scopes it to a group of new employees. Maria can change the default settings and see a list of all the passes that are issued on the Contoso tenant. In some configurations, when Maria enables FIDO or Phone sign-in, Access Pass 202 is also enabled for the same groups, as this is a supporting credential for passwordless.

End user registering strong credentials on a first day using a kiosk machine. Contoso has enabled passwordless authentication for its employees. Ben is a new employee at Contoso. On his first day he needs to prove his identity and register his credentials. Cora is a help desk admin who helps Ben to onboard his credentials. After she verifies Ben's identity, she provides him an Access Pass 202. Ben uses the Access Pass to register his credentials on a kiosk machine. Once Ben has registered his passwordless credentials, he can open the laptop provided by Cora and bootstrap its authentication, e.g., MFA or biometric or other strong authentication. Each organization may have a different process for verifying the user's identity before providing the Access Pass 202. Access Pass 202 can also be provided in different ways to the user, for example the information technology (IT) department may send it via a dedicated app they are developing or via SMS. Other organizations might print it or write it on a paper. APIs to generate the Access Pass are provided in many if not all embodiments.

Authentication Admin generating Access Pass to end user on their first day. Cora is the help desk admin who helps Ben to onboard his Passwordless credentials. She goes into the TAP cloud portal, finds Ben's user account under Users and clicks on it. She can generate a new Access Pass that starts, e.g., in 15 minutes. She writes the pass on a note and gives it to Ben.

Onboarding new passwordless user using a custom identity proofing process. A Privileged Authentication Admin or other authorized personnel can configure an Access Pass policy for their cloud tenant. Lee is the Privileged Authentication Admin for Contoso. He would like to enable Passwordless authentication in the tenant. He uses an API to enable the FIDO, Phone sign-in and Access Pass authentication methods on the Contoso tenant and scopes it to an inner-ring group.

End user who had passwordless credentials recovering their credentials after losing all passwordless credentials. Back to Ben, a year later on a business trip, he lost his mobile device and laptop. He bought a new phone and he needs to access his mail on the device. He calls the help desk to report the lost. The help desk admin verifies Ben's identity and provides him with a new Access Pass 202. In addition, since Ben lost his device, the admin deletes his credentials and revokes all his sessions. Using the Access Pass 202, Ben goes to manage his credentials and register the authenticator app for passwordless credentials. Ben can then use the authenticator app to access his mail.

End user who had passwordless credentials accessing their account when their credentials are temporary unavailable. Contoso requires multifactor factor authentication to access their application. Kelly has arrived at the office and realizes she had forgotten her phone and cannot access her account. She goes to the help desk in the office, which verifies her identity and then issues her a one-time bypass 202 that can be used for the day (8 hours) and will allow her to access her account. Since she only forgot her phone and didn't lose it, the admin will not delete her credentials.

In some embodiments, TAP 202 attributes are configurable, e.g., as tenant level policy, e.g., by a Global Admin or Privileged Authentication admin. Policy may support different scopes so admins can configure different policies for members, guest and different administrative units.

In some embodiments, TAPs 202 and related aspects of the embodiment are further characterized in one or more of the following ways.

All passes are revokable.

Only specified admins can scope the TAP-governing policy for groups (in addition to policy for all users).

For privileged users, only specified admins can create an Access Pass 202.

A user can only have one valid pass 202 at a given time; creating a new pass will override the existing pass.

Usage of a pass 202 is protected from brute force using smart lockout.

Throttling defines how many passes 202 can be created on a user on a given time. For example, not more than three within 24 hours.

An Access Pass 202 can be issued when the user has other methods registered (recovery scenario—user lost their devices and needs Access Pass to recover their strong credentials).

Some possible failure reasons for not creating a requested pass 202 include: Time limit on the pass exceeded the policy, User is not in the scope of the policy.

User notification is performed, e.g., when a new access pass is created, email the user to alert them on the change to their account. As a security measure, it is prudent to not send the TAP itself by email.

Pass 202 can be created with a start time that is in the past, e.g., up to ten minutes in the past. If a user sits at the activate page for more than, e.g., ten minutes, pass 202 activation fails and the user sees an error message. If the user tries to set a start time that is longer than, e.g., ten minutes in the past, this embodiment shows an error message that the start time should be now.

When a user has a valid Access Pass 202, it is preferred over FIDO or an authenticator app.

When an Access Pass 202 has expired (or been revoked), the token lifetime is expired. As a result, when the user's access pass has expired, they need to sign-in again, this time with their new credentials.

As to lockout, password and access pass may be counted separately or together. To remediate a lockout a user can wait or can be issued a new pass.

After a user signed in with another authentication method, the embodiment revokes the pass 202.

Guest users must satisfy the authentication requirement in all applicable contexts, e.g., both home and resource tenant.

The admin interface cannot retrieve or re-display the TAP passcode later. However, an admin may revoke or delete a TAP using the admin interface. In some embodiments, a CCE or other API and interface that generates TAPs and manages TAP lifecycles can never read (and hence never display) the TAPs. In general, a user must have specified admin privileges to cause a system to generate 638 a TAP 202. In some, the system 200 stores the TAP 202 in MSODS or another directory service, encrypts the TAP, and allows decryption of the TAP only by a specified component, e.g., ESTS (Evolved Security Token Service) or a similar security service. In some TAP consumption is managed solely by specific components, e.g., solely by ESTS. In some, CCE and ESTS or their counterpart components do not interact directly for TAP management.

Although TAP and conventional MFA can co-exist, in some scenarios TAP replaces some or all kinds of MFA. In some, only the TAP will work for a particular cybersecurity operation.

Although a TAP will normally be limited to use by a single identity, a group TAP is possible in some scenarios. For example, usage of a TAP can be restricted 404 to a segment of the population. An admin can decide which audience of users 104 is eligible for the TAP 202. This can be useful when a TAP is multi-use and an elevated level of trust is required to allocate 638 the TAP. In some embodiments, CCE polices or other policies support such TAP management.

Policy may specify that there are permitted channels and prohibited channels for TAP distribution. For example, a phone call or face-to-face may be permitted channels for an admin to give someone a TAP, while sending a TAP by email may be prohibited by a policy.

Some scenarios utilize decentralized identity, where a third party such as bank, university, or driver license division provides info 428 to support a claim to the digital identity before the digital identity 206 is associated with the TAP. This may also be part of a self-service process for getting a TAP.

In some embodiments, TAPs could be either single-use or multi-use. If multi-use, one can use the TAP multiple times until its expiry, e.g., an admin may configure a TAP to allow the TAP to be used at most three times for signing in. This helps with the usability of the solution. By contrast, an authentication approach using an emailed magic code may also only one-time use of the magic code.

In some embodiments, TAP creation is automatically governed by policy. The TAP expiry date is a configurable default set or by an admin via an authentication method policy. This may also be overridden at an individual TAP level granularity.

In some embodiments, a TAP can be used to bootstrap passwordless credentials, and each credential may have a different flow. For FIDO2, for example, a user may go to a specified web page and sign-in with a TAP, after which they can register their FIDO2 key. For Phone Sign-in (Passwordless Phone Sign-in with an authenticator app), the user can download the app and then click “add account”. From there they can use their TAP and start a registration flow. This avoids having users scan a QR code to register the app and then take additional steps within the app. For authentication bootstrapping of a new device during setup during the device OOBE (out of the box experience), users can use the TAP during an enrollment process instead of using a password plus MFA. These flows are merely illustrative examples.

Additional support for the discussion above is provided below. For convenience, this additional support material appears under various headings. Nonetheless, it is all intended to be understood as an integrated and integral part of the present disclosure's discussion of the contemplated embodiments.

Technical Character

The technical character of embodiments described herein will be apparent to one of ordinary skill in the art, and will also be apparent in several ways to a wide range of attentive readers. Some embodiments address technical activities such as registering 602 authentication methods 204, granting 622 or denying 624 access to digital resources 438, and computationally associating 632 an identity 206 in a computing system 200 with a usage-limited passcode 202 which are each an activity deeply rooted in computing technology. Some of the technical mechanisms discussed include, e.g., usage-limited passcodes 202, enhanced access control infrastructures 210, hardware security keys 304, biometric data 312, smart phones 308, PINs 316, authentication credentials 318, and usage constraints 404. Some of the technical effects discussed include, e.g., bootstrapping of passwordless 314 authentication methods 204, recovery of access despite loss or unavailability of a particular device 310, and avoidance of reliance on username 416 password 418 pairs for authentication 508. Thus, purely mental processes and activities limited to pen-and-paper are clearly excluded. Other advantages based on the technical characteristics of the teachings will also be apparent to one of skill from the description provided.

Some embodiments described herein may be viewed by some people in a broader context. For instance, concepts such as confidentiality, data integrity, efficiency, privacy, speed, or trust may be deemed relevant to a particular embodiment. However, it does not follow from the availability of a broad context that exclusive rights are being sought herein for abstract ideas; they are not. Rather, the present disclosure is focused on providing appropriately specific embodiments whose technical effects fully or partially solve particular technical problems, such as how to: automatically and effectively onboard a new employee's access, or recover access despite the loss or unavailability of a particular device. Other configured storage media, systems, and processes involving confidentiality, data integrity, efficiency, privacy, speed, or trust are outside the present scope. Accordingly, vagueness, mere abstractness, lack of technical character, and accompanying proof problems are also avoided under a proper understanding of the present disclosure.

### Additional Combinations and Variations

Any of these combinations of code, data structures, logic, components, communications, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the configured storage medium combinations and variants described above.

More generally, one of skill will recognize that not every part of this disclosure, or any particular details therein, are necessarily required to satisfy legal criteria such as enablement, written description, or best mode. Also, embodiments are not limited to the particular motivating examples and scenarios, flows, operating environments, time period examples, software processes, security tools, identifiers, data structures, data selections, naming conventions, notations, or other implementation choices described herein. Any apparent conflict with any other patent disclosure, even from the owner of the present innovations, has no role in interpreting the claims presented in this patent disclosure.

### Acronyms, Abbreviations, Names, and Symbols

Some acronyms, abbreviations, names, and symbols are defined below. Others are defined elsewhere herein, or do not require definition here in order to be understood by one of skill.

ALU: arithmetic and logic unit

API: application program interface

BIOS: basic input/output system

CD: compact disc

CPU: central processing unit

DVD: digital versatile disk or digital video disc

FPGA: field-programmable gate array

FPU: floating point processing unit

GPU: graphical processing unit

GUI: graphical user interface

HTTP(S): hypertext transfer protocol (secure)

IaaS or IAAS: infrastructure-as-a-service

ID: identification or identity

IoT: Internet of Things

IP: internet protocol

LAN: local area network

OS: operating system

PaaS or PAAS: platform-as-a-service

RAM: random access memory

ROM: read only memory

TCP: transmission control protocol

TLS: transport layer security

TPU: tensor processing unit

UDP: user datagram protocol

UEFI: Unified Extensible Firmware Interface

URI: uniform resource identifier

URL: uniform resource locator

WAN: wide area network

### Some Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise the right to specific and chosen lexicography. Quoted terms are being defined explicitly, but a term may also be defined implicitly without using quotation marks. Terms may be defined, either explicitly or implicitly, here in the Detailed Description and/or elsewhere in the application file.

A “computer system” (a.k.a. “computing system”) may include, for example, one or more servers, motherboards, processing nodes, laptops, tablets, personal computers (portable or not), personal digital assistants, smartphones, smartwatches, smartbands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

An “administrator” (or “admin”) is any user that has legitimate access (directly or indirectly) to multiple accounts of other users by using their own account's credentials. Some examples of administrators include network administrators, system administrators, domain administrators, privileged users, service provider personnel, and security infrastructure administrators.

A “multithreaded” computer system is a computer system which supports multiple execution threads. The term “thread” should be understood to include code capable of or subject to scheduling, and possibly to synchronization. A thread may also be known outside this disclosure by another name, such as “task,” “process,” or “coroutine,” for example. However, a distinction is made herein between threads and processes, in that a thread defines an execution path inside a process. Also, threads of a process share a given address space, whereas different processes have different respective address spaces. The threads of a process may run in parallel, in sequence, or in a combination of parallel execution and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, machine learning, and so on.

“Kernels” include operating systems, hypervisors, virtual machines, BIOS or UEFI code, and similar hardware interface software.

“Code” means processor instructions, data (which includes constants, variables, and data structures), or both instructions and data. “Code” and “software” are used interchangeably herein. Executable code, interpreted code, and firmware are some examples of code.

“Program” is used broadly herein, to include applications, kernels, drivers, interrupt handlers, firmware, state machines, libraries, and other code written by programmers (who are also referred to as developers) and/or automatically generated.

A “routine” is a callable piece of code which normally returns control to an instruction just after the point in a program execution at which the routine was called. Depending on the terminology used, a distinction is sometimes made elsewhere between a “function” and a “procedure”: a function normally returns a value, while a procedure does not. As used herein, “routine” includes both functions and procedures. A routine may have code that returns a value (e.g., sin(x)) or it may simply return without also providing a value (e.g., void functions).

“Service” means a consumable program offering, in a cloud computing environment or other network or computing system environment, which provides resources to multiple programs or provides resource access to multiple programs, or does both.

“Cloud” means pooled resources for computing, storage, and networking which are elastically available for measured on-demand service. A cloud may be private, public, community, or a hybrid, and cloud services may be offered in the form of infrastructure as a service (IaaS), platform as a service (PaaS), software as a service (SaaS), or another service. Unless stated otherwise, any discussion of reading from a file or writing to a file includes reading/writing a local file or reading/writing over a network, which may be a cloud network or other network, or doing both (local and networked read/write).

“IoT” or “Internet of Things” means any networked collection of addressable embedded computing or data generation or actuator nodes. Such nodes may be examples of computer systems as defined herein, and may include or be referred to as a “smart” device, “endpoint”, “chip”, “label”, or “tag”, for example, and IoT may be referred to as a “cyber-physical system”. IoT nodes and systems typically have at least two of the following characteristics: (a) no local human-readable display; (b) no local keyboard; (c) a primary source of input is sensors that track sources of non-linguistic data to be uploaded from the IoT device; (d) no local rotational disk storage— RAM chips or ROM chips provide the only local memory; (e) no CD or DVD drive; (f) embedment in a household appliance or household fixture; (g) embedment in an implanted or wearable medical device; (h) embedment in a vehicle; (i) embedment in a process automation control system; or (j) a design focused on one of the following: environmental monitoring, civic infrastructure monitoring, agriculture, industrial equipment monitoring, energy usage monitoring, human or animal health or fitness monitoring, physical security, physical transportation system monitoring, object tracking, inventory control, supply chain control, fleet management, or manufacturing. IoT communications may use protocols such as TCP/IP, Constrained Application Protocol (CoAP), Message Queuing Telemetry Transport (MQTT), Advanced Message Queuing Protocol (AMQP), HTTP, HTTPS, Transport Layer Security (TLS), UDP, or Simple Object Access Protocol (SOAP), for example, for wired or wireless (cellular or otherwise) communication. IoT storage or actuators or data output or control may be a target of unauthorized access, either via a cloud, via another network, or via direct local access attempts.

“Access” to a computational resource includes use of a permission or other capability to read, modify, write, execute, move, delete, create, or otherwise utilize the resource. Attempted access may be explicitly distinguished from actual access, but “access” without the “attempted” qualifier includes both attempted access and access actually performed or provided.

“Secured” means only that some security is provided, not that the effectiveness of the security is guaranteed.

As used herein, “include” allows additional elements (i.e., includes means comprises) unless otherwise stated.

“First” and “second” simply mean different, like subscripts j and kin math, or hypothetical items X and Y. That is, “first” and “second” do not mean anything so far as time or occurrence or relative position are concerned.

“Optimize” means to improve, not necessarily to perfect. For example, it may be possible to make further improvements in a program or an algorithm which has been optimized.

A cybersecurity operation is “ineffective” when it is not performed at all, or when it returns an error code, or when it does not do at least one of the following: grant a requested access, grant a requested change in registered authentication methods or credentials, grant a requested change in privilege, or change (add, delete, modify) a user identity.

“Process” is sometimes used herein as a term of the computing science arts, and in that technical sense encompasses computational resource users, which may also include or be referred to as coroutines, threads, tasks, interrupt handlers, application processes, kernel processes, procedures, or object methods, for example. As a practical matter, a “process” is the computational entity identified by system utilities such as Windows® Task Manager, Linux® ps, or similar utilities in other operating system environments (marks of Microsoft Corporation, Linus Torvalds, respectively). “Process” is also used herein as a patent law term of art, e.g., in describing a process claim as opposed to a system claim or an article of manufacture (configured storage medium) claim. Similarly, “method” is used herein at times as a technical term in the computing science arts (a kind of “routine”) and also as a patent law term of art (a “process”). “Process” and “method” in the patent law sense are used interchangeably herein. Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided. Steps performed automatically are presumed to include at least one operation performed proactively.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment, particularly in real-world embodiment implementations. Authentication support operations such as generating 638 TAPs 202, confirming 504 TAP validity, ascertaining 506 user identity 206, and authenticating 508 based on a TAP, are understood to be inherently digital. A human mind cannot interface directly with a CPU or other processor, or with RAM or other digital storage, to read and write the necessary data to perform the authentication support steps taught herein. This would all be well understood by persons of skill in the art in view of the present disclosure.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user. Indeed, a user may not even realize that a proactive step by an embodiment was possible until a result of the step has been presented to the user. Except as otherwise stated, any computational and/or automatic step described herein may also be done proactively.

Throughout this document, use of the optional plural “(s)”, “(es)”, or “(ies)” means that one or more of the indicated features is present. For example, “processor(s)” means “one or more processors” or equivalently “at least one processor”.

For the purposes of United States law and practice, use of the word “step” herein, in the claims or elsewhere, is not intended to invoke means-plus-function, step-plus-function, or 35 United State Code Section 112. Sixth Paragraph/Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure's text. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, or disclosed as having a functional relationship with the structure or operation of a zac widget, would be deemed part of the structures identified in the application for zac widgets and would help define the set of equivalents for zac widget structures.

One of skill will recognize that this innovation disclosure discusses various data values and data structures, and recognize that such items reside in a memory (RAM, disk, etc.), thereby configuring the memory. One of skill will also recognize that this innovation disclosure discusses various algorithmic steps which are to be embodied in executable code in a given implementation, and that such code also resides in memory, and that it effectively configures any general-purpose processor which executes it, thereby transforming it from a general purpose processor to a special-purpose processor which is functionally special-purpose hardware.

Accordingly, one of skill would not make the mistake of treating as non-overlapping items (a) a memory recited in a claim, and (b) a data structure or data value or code recited in the claim. Data structures and data values and code are understood to reside in memory, even when a claim does not explicitly recite that residency for each and every data structure or data value or piece of code mentioned. Accordingly, explicit recitals of such residency are not required. However, they are also not prohibited, and one or two select recitals may be present for emphasis, without thereby excluding all the other data values and data structures and code from residency. Likewise, code functionality recited in a claim is understood to configure a processor, regardless of whether that configuring quality is explicitly recited in the claim.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a step involving action by a party of interest such as accessing, allowing, ascertaining, associating, authenticating, computing, confirming, denying, determining, displaying, generating, getting, granting, implementing, monitoring, obtaining, presenting, processing, producing, providing, receiving, redirecting, registering, revoking, running, selecting, sending, setting, specifying, treating, utilizing, (and accesses, accessed, allows, allowed, etc.) with regard to a destination or other subject may involve intervening action such as the foregoing or forwarding, copying, uploading, downloading, encoding, decoding, compressing, decompressing, encrypting, decrypting, authenticating, invoking, and so on by some other party, including any action recited in this document, yet still be understood as being performed directly by the party of interest.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other computer-readable storage medium is not a propagating signal or a carrier wave or mere energy outside the scope of patentable subject matter under United States Patent and Trademark Office (USPTO) interpretation of the In re Nuijten case. No claim covers a signal per se or mere energy in the United States, and any claim interpretation that asserts otherwise in view of the present disclosure is unreasonable on its face. Unless expressly stated otherwise in a claim granted outside the United States, a claim does not cover a signal per se or mere energy.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

### LIST OF REFERENCE NUMERALS

The following list is provided for convenience and in support of the drawing figures and as part of the text of the specification, which describe innovations by reference to multiple items. Items not listed here may nonetheless be part of a given embodiment. For better legibility of the text, a given reference number is recited near some, but not all, recitations of the referenced item in the text. The same reference number may be used with reference to different examples or different instances of a given item. The list of reference numerals is:

100 operating environment, also referred to as computing environment

102 computer system, also referred to as a “computational system” or “computing system”, and when in a network may be referred to as a “node”

104 users, e.g., user of an enhanced system 200

106 peripherals

108 network generally, including, e.g., LANs, WANs, software-defined networks, clouds, and other wired or wireless networks

110 processor

112 computer-readable storage medium, e.g., RAM, hard disks; also referred to broadly as “memory”, which may be volatile or nonvolatile, or a mix

114 removable configured computer-readable storage medium

116 instructions executable with processor; may be on removable storage media or in other memory (volatile or nonvolatile or both)

118 data

120 kernel(s), e.g., operating system(s), BIOS, UEFI, device drivers

122 tools, e.g., anti-virus software, firewalls, packet sniffer software, intrusion detection systems, intrusion prevention systems, other cybersecurity tools, debuggers, profilers, compilers, interpreters, decompilers, assemblers, disassemblers, source code editors, autocompletion software, simulators, fuzzers, repository access tools, version control tools, optimizers, collaboration tools, other software development tools and tool suites (including, e.g., integrated development environments), hardware development tools and tool suites, diagnostics, and so on

124 applications, e.g., word processors, web browsers, spreadsheets, games, email tools, commands

126 display screens, also referred to as “displays”

128 computing hardware not otherwise associated with a reference number 106, 108, 110,

200 computing system 102 enhanced with authentication functionality taught herein, e.g., with one or more of a TAP 202, enhanced infrastructure 210, usage constraint 404, functionality according to FIG. 5 or 6, or any other functionality first taught herein

202 usage-limited passcode; also referred to herein as “temporary access pass”, “Access Pass”, “pass 202”, “TAP”, or “passcode”

204 authentication method; performed computationally

206 user identity data structure(s) in a computing system

208 access control to resources or services in a computing system, e.g., data and instructions which control one or more kinds of access to an item, where some examples of “access” include read, write, move, encrypt, decrypt, compress, decompress, or otherwise perform computational action on or using the item

210 computational access control infrastructure, e.g., identity management data and instructions, permissions checks, cybersecurity mechanisms, software and hardware for logging, auditing, authenticating

212 computing system 102 to which access is sought

302 possession or control of an item

304 hardware security key

306 item which is FIDO (Fast IDentity Online) compliant, e.g., compliant with one or more standards or specifications published or endorsed by the FIDO Alliance (fidoalliance dot org) as of the filing data of the present disclosure, or hereafter published or endorsed by the FIDO Alliance or any successor thereof, whether

308 smart phone, e.g., any portable computing device equipped with telecommunication capability

310 a particular computing device 102 as identified, e.g., by any embedded identifier or set of identifying characteristics

312 biometric data, or device for obtaining or verifying biometric data

314 quality of password non-inclusion or non-reliance on a password for authentication to a computing system

316 PIN (personal identification number)

318 authentication or authorization credential in a computing system

402 usage of a TAP for authentication (“authentication” herein includes both authentication per se and authorization)

404 computationally specified and implemented constraint on TAP usage 402

406 number of permitted uses 402 of a TAP; digital

408 kind of permitted uses 402 of a TAP; digital; e.g., for passwordless authentication method registration only, or for any operation 410

410 computational operation

412 computational administrative interface

414 computational administrative interface authentication mechanism, e.g., authentication method 204

416 username

418 password or passphrase

420 secured mobile application, e.g., an authenticator app

422 SMS or text message, or transmission/receipt thereof

424 email message, or transmission/receipt thereof

426 time period

428 confirmation of identity; data structure, digital message, or otherwise computational

430 procedure for confirming an assertion of identity; computational

432 privilege level or access rights in a computing system

434 federated domain computing system

436 identity provider, e.g., identity directory in or fora federated domain

438 digital service or resource in a computing system

440 device identifier, e.g., MAC (medium access control) address, IMEI (international mobile equipment identity) number, ESN (equipment serial number) number, or hardware key

500 flowchart; 500 also refers to authentication methods illustrated by or consistent with the FIG. 5 flowchart

502 computationally receive a usage-limited passcode 202

504 computationally confirm validity of the usage-limited passcode, e.g., by checking against constraints 404

506 computationally ascertain user identity associated with usage-limited passcode, e.g., by checking TAP data structure against username entered in a session in which TAP is received 502

508 computationally authenticate based on TAP, e.g., by treating valid TAP as substitute or replacement for other credentials such as password

600 flowchart; 600 also refers to authentication support methods illustrated by or consistent with the FIG. 6 flowchart (which incorporates the steps of FIG. 5)

602 computationally register an authentication method for authenticating to an account of a user identity

604 computationally treat a TAP as invalid, e.g., by denying access based on TAP authentication

606 computationally treat a TAP as valid, e.g., by granting access based on TAP authentication

608 computationally attempt to access a secured resource

610 computationally access a secured resource

612 secured resource in a computing system; digital

614 computationally display a TAP, e.g., on a screen 126 or by synthesized speech via a speaker

616 computationally perform an operation 410

618 avoid redirection 620 to a federated domain identity provider, e.g., authenticate without first accessing the federated domain identity provider

620 computationally redirect an authentication flow to a federated domain identity provider

622 computationally grant access to a digital resource

624 computationally deny access to a digital resource

626 computationally elevate a privilege level or otherwise grant access rights in a computing system

628 avoid transmitting data over a specified channel; computational

630 transmit data over a specified channel; computational

632 computationally associate an identity 206 with a TAP 202, e.g., in a data structure

634 computationally specify a TAP 202 constraint 404, e.g., in a data structure

636 computationally get an identity confirmation 428

638 computationally generate a TAP 202, e.g., as a random or pseudorandom string of predetermined length

640 computationally interact with a user, e.g., via peripheral 106

642 computationally attempt to authenticate for access to a resource

644 computationally set a TAP 202 constraint during interaction 640

646 any step discussed in the present disclosure that has not been assigned some other reference numeral

### CONCLUSION

In short, the teachings herein provide a variety of authentication support functionalities which operate in enhanced systems 200. Usage-limited passcodes 202 support authentication 508 when onboarding new employees, when recovering access 610 after an enrolled device 310 is lost or temporarily unavailable, or when registering 602 passwordless 314 authentication methods 204 for new devices 102 during an out of the box setup, among other scenarios. Usage-limited passcodes 202 are also referred to as “temporary access passes” or TAPs 202. TAP 202 usage 402 may be limited 404 to a specific number 406 of uses, particular kinds 408 of uses, certain time periods 426, or a combination thereof. A TAP 202 includes a code string and an implementation of corresponding tokens, rights, and other identity aspects within an enhanced access control infrastructure 210. TAP usage 402 may supplement or replace other authentication, and in particular may replace authentication through a username 416 and password 418 combination, thereby enhancing both usability and security. Self-service identity confirmation 636 may be used to obtain a TAP 202. Redirection 620 to a federated domain 434 identity provider 436 may be avoided 618 during TAP authentication 508, 500.

Embodiments are understood to also themselves include or benefit from tested and appropriate security controls and privacy controls such as the General Data Protection Regulation (GDPR), e.g., it is understood that appropriate measures should be taken to help prevent misuse of computing systems through the injection or activation of malware. Use of the tools and techniques taught herein is compatible with use of such controls.

Although Microsoft technology is used in some motivating examples, the teachings herein are not limited to use in technology supplied or administered by Microsoft. Under a suitable license, for example, the present teachings could be embodied in software or services provided by other cloud service providers.

Although particular embodiments are expressly illustrated and described herein as processes, as configured storage media, or as systems, it will be appreciated that discussion of one type of embodiment also generally extends to other embodiment types. For instance, the descriptions of processes in connection with FIGS. 6 through 9 also help describe configured storage media, and help describe the technical effects and operation of systems and manufactures like those discussed in connection with other Figures. It does not follow that limitations from one embodiment are necessarily read into another. In particular, processes are not necessarily limited to the data structures and arrangements presented while discussing systems or manufactures such as configured memories.

Those of skill will understand that implementation details may pertain to specific code, such as specific thresholds, comparisons, specific kinds of runtimes or programming languages or architectures, specific scripts or other tasks, and specific computing environments, and thus need not appear in every embodiment. Those of skill will also understand that program identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

With due attention to the items provided herein, including technical processes, technical effects, technical mechanisms, and technical details which are illustrative but not comprehensive of all claimed or claimable embodiments, one of skill will understand that the present disclosure and the embodiments described herein are not directed to subject matter outside the technical arts, or to any idea of itself such as a principal or original cause or motive, or to a mere result per se, or to a mental process or mental steps, or to a business method or prevalent economic practice, or to a mere method of organizing human activities, or to a law of nature per se, or to a naturally occurring thing or process, or to a living thing or part of a living thing, or to a mathematical formula per se, or to isolated software per se, or to a merely conventional computer, or to anything wholly imperceptible or any abstract idea per se, or to insignificant post-solution activities, or to any method implemented entirely on an unspecified apparatus, or to any method that fails to produce results that are useful and concrete, or to any preemption of all fields of usage, or to any other subject matter which is ineligible for patent protection under the laws of the jurisdiction in which such protection is sought or is being licensed or enforced.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable storage medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Distinct steps may be shown together in a single box in the Figures, due to space limitations or for convenience, but nonetheless be separately performable, e.g., one may be performed without the other in a given performance of a method.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a”, “an”, and “the” are inclusive of one or more of the indicated item or step. In particular, in the claims a reference to an item generally means at least one such item is present and a reference to a step means at least one instance of the step is performed. Similarly, “is” and other singular verb forms should be understood to encompass the possibility of “are” and other plural forms, when context permits, to avoid grammatical errors or misunderstandings.

Headings are for convenience only; information on a given topic may be found outside the section whose heading indicates that topic.

All claims and the abstract, as filed, are part of the specification.

To the extent any term used herein implicates or otherwise refers to an industry standard, and to the extent that applicable law requires identification of a particular version of such as standard, this disclosure shall be understood to refer to the most recent version of that standard which has been published in at least draft form (final form takes precedence if more recent) as of the earliest priority date of the present disclosure under applicable patent law.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A computing system configured with passwordless authentication support, the system comprising:
a digital memory; and
a processor in operable communication with the digital memory, the processor configured to perform passwordless authentication support steps including (a) receiving a usage-limited passcode, (b) confirming that the usage-limited passcode has not expired or been used a maximum number of permitted times, (c) ascertaining a user identity which is securely and exclusively associated with the usage-limited passcode within the system, and (d) registering in the system a passwordless authentication method for authentication of the user identity.

2. The system of claim 1, wherein the passwordless authentication method comprises at least one of the following:
a FIDO-compliant passwordless authentication method;
a passwordless authentication method based on possession of a hardware security key;
a passwordless authentication method based on possession of a particular smart phone;
a passwordless authentication method based on possession of a particular computing device; or
a passwordless authentication method based on biometric data.

3. The system of claim 1, further characterized by at least one of the following usage constraints:
the usage-limited passcode is treated by the system as invalid after the passwordless authentication method has been registered;
the usage-limited passcode is treated by the system as valid for a predetermined number of additional uses after being used to register the passwordless authentication method, and the usage-limited passcode is treated by the system as invalid otherwise;
the usage-limited passcode is treated by the system as valid for registering at least one additional passwordless authentication method for authentication of the user identity, and the usage-limited passcode is treated by the system as invalid otherwise; or
the usage-limited passcode is bound to a device having a device identifier, and is treated by the system as invalid if received from a device which does not have that device identifier.

4. The system of claim 1, further comprising an administrative interface which is secured by an administrator authentication mechanism, the administrative interface configured to display the usage-limited passcode.

5. The system of claim 4, wherein the administrative interface is configured to display the usage-limited passcode only once.

6. The system of claim 1, wherein the system comprises a secured resource, the secured resource is accessible to the user identity in response to a first authentication attempt which uses the registered passwordless authentication method, and the secured resource is secured against access by a second authentication attempt which relies on only a username and password as authentication credentials.

7. A process providing passwordless authentication support, the process carried out within a computing system, the process comprising:
receiving a usage-limited passcode;
confirming that the usage-limited passcode satisfies a set of one or more usage constraints;
ascertaining a user identity which is securely associated with the usage-limited passcode within the computing system; and
performing at least one cybersecurity operation within the computing system in reliance on the usage-limited passcode as an authentication credential, the cybersecurity operation ineffective in response to a username and a password alone for authentication.

8. The process of claim 7, wherein the cybersecurity operation comprises at least one of the following:
granting access to a secured resource;
registering a passwordless authentication method; or
elevating a privilege level.

9. The process of claim 7, wherein the cybersecurity operation is also ineffective in response to any existing authentication credential of the user identity other than the usage-limited passcode.

10. The process of claim 7, wherein multiple user identities are each securely associated with the usage-limited passcode within the computing system at a given time.

11. The process of claim 7, further comprising at least one of the following:
transmitting the usage-limited passcode via a secured mobile application;
avoiding transmitting the usage-limited passcode via email; or
avoiding transmitting the usage-limited passcode via SMS or text.

12. The process of claim 7, further comprising setting at least one of the following usage constraints on the usage-limited passcode:
a usage count constraint specifying a maximum number of times the usage-limited passcode is effectively usable;
a usage periods constraint specifying a time period inside of which the usage-limited passcode is effective and outside of which the usage-limited passcode is ineffective;
a usage kind constraint specifying one or more cybersecurity operations which are effective if authenticated by the usage-limited passcode; or
a usage kind constraint specifying one or more cybersecurity operations which are effective only if authenticated by the usage-limited passcode.

13. The process of claim 7, further comprising:
getting a digital identity confirmation which confirms an identity claim; and
securely associating the usage-limited passcode with the user identity based at least in part on the digital identity confirmation.

14. The process of claim 7, further comprising:
interacting with a user during a self-service identity confirmation procedure;
generating the usage-limited passcode; and
securely associating the usage-limited passcode with the user identity based at least in part on a result of the self-service identity confirmation procedure.

15. A computer-readable storage device configured with data and instructions which upon execution by a processor cause a cloud computing system to perform a process for authentication support, the process comprising:
receiving a usage-limited passcode;
confirming that the usage-limited passcode is valid;
ascertaining a user identity which is securely and exclusively associated with the usage-limited passcode within the system; and
authenticating the user identity in the system based on the usage-limited passcode.

16. The storage device of claim 15, wherein the process includes registering in the system a passwordless authentication method for authentication of the user identity, and wherein the passwordless authentication method is based on at least one of the following:
possession of an enrolled device and a PIN; or
possession of an enrolled device and a biometric characteristic.

17. The storage device of claim 15, further characterized by a usage constraint under which the usage-limited passcode is treated by the system as invalid after one successful sign-in.

18. The storage device of claim 15, further characterized by a usage constraint under which the usage-limited passcode is treated by the system as valid for a predetermined number of uses, and the usage-limited passcode is then treated by the system as invalid.

19. The storage device of claim 15, wherein the user identity is part of a federated domain having a federated domain identity provider, and wherein authenticating the user identity in the system based on the usage-limited passcode comprises avoiding redirection to the federated domain identity provider.

20. The storage device of claim 15, wherein the process further comprises at least one of the following:
granting the user identity access to a secured resource;
registering a passwordless authentication method for the user identity; or
elevating a privilege level of the user identity.
